(19) United States
(12) Patent Application Publication
(10) Pub. No.: US 2024/0167435 A1
(43) Pub. Date: May 23, 2024

(54) MULTIPULSE ROCKET MOTOR WITH PRESSURE-EQUALIZING CHANNELS

(71) Applicant: Raytheon Company, Waltham, MA (US)

(72) Inventors: Allan Dokhan, Tucson, AZ (US); Lauren Elizabeth Brunacini, Tucson, AZ (US); Charles R. Lustenberger, Tucson, AZ (US)

(21) Appl. No.: 18/057,958

(22) Filed: Nov. 22, 2022

(51) Int. Cl. F02K 9/95; F02K 9/70

(52) U.S. Cl. CPC F02K 9/95; F02K 9/70

(57) ABSTRACT

A multipulse rocket motor includes a secondary pulse, fired after a primary pulse of the motor, that includes a thermal insulator having channels therein, around a propellant grain of the secondary pulse. The channels provide a way to equalize pressure on the propellant grain of the secondary pulse, to reduce stresses on the propellant grain as the primary pulse is operating. The channels may extend along most or substantially all of a length of the secondary pulse. The channels may be defined by material strips of thermal insulator material evenly circumferentially spaced around the secondary pulse.

### GOVERNMENT LICENSE RIGHTS

This disclosure was made with Government support under contract number FA8651-20-D-0001, awarded by the United States Air Force. The Government has certain rights in the invention.

### FIELD

The disclosure is in the field of rocket motors and associated propulsion systems.

### BACKGROUND

In pulsed rocket motors the propellent grains may be cast-in-case grains. Such grains provide advantageous performance because of reduction of excess inert weight due to the propellent grain being cast directly in a casing. However such grain configurations raise the potential for destructive pressure gradients in operation, as well as other stress/strain relief problems.

### SUMMARY

A multipulse rocket motor includes a secondary pulse that includes channels, such as around a perimeter of the secondary pulse, that provide pressure equalization around a propellant grain of the secondary pulse. The channels may reduce stresses/strains on the secondary pulse propellant grain, such as may occur during operation of a primary pulse of the multipluse rocket motor.

According to an aspect of the disclosure, a multipulse rocket motor includes: a primary pulse; and a secondary pulse fired after the primary pulse; wherein the secondary pulse includes a thermal insulator around a propellant grain of the secondary pulse; and wherein the thermal insulator defines channels therein.

According to an embodiment of any paragraph(s) of this summary, the channels are in fluid communication with the primary pulse.

According to an embodiment of any paragraph(s) of this summary, the thermal insulator is around a perimeter of the secondary pulse.

According to an embodiment of any paragraph(s) of this summary, the thermal insulator is between the propellant grain of the secondary pulse, and a casing surrounding the thermal insulator.

According to an embodiment of any paragraph(s) of this summary, the channels extend longitudinally along a length of the secondary pulse.

According to an embodiment of any paragraph(s) of this summary, the thermal insulator includes material strips between an inner insulator layer and an outer insulator layer.

According to an embodiment of any paragraph(s) of this summary, the material strips include at least four material strips.

According to an embodiment of any paragraph(s) of this summary, the material strips are evenly perimetrically spaced about the thermal insulator.

According to an embodiment of any paragraph(s) of this summary, the material strips extend longitudinally less than all of a length of the secondary pulse.

According to an embodiment of any paragraph(s) of this summary, the propellant grain of the secondary pulse is a cast-in-case propellant grain.

According to an embodiment of any paragraph(s) of this summary, the secondary pulse is a second pulse of a two-pulse rocket motor.

According to an embodiment of any paragraph(s) of this summary, the secondary pulse is an annular secondary pulse.

According to an embodiment of any paragraph(s) of this summary, the thermal insulator is cylindrical.

According to an embodiment of any paragraph(s) of this summary, the channels extend at least 50% of a length of the secondary pulse.

According to an embodiment of any paragraph(s) of this summary, the channels extend at least 75% of a length of the secondary pulse.

According to an embodiment of any paragraph(s) of this summary, the channels extend at least 90% of a length of the secondary pulse.

According to an embodiment of any paragraph(s) of this summary, the rocket motor further includes a barrier between the primary pulse and the secondary pulse.

According to an embodiment of any paragraph(s) of this summary, the barrier a flexible barrier.

According to an embodiment of any paragraph(s) of this summary, the rocket motor is part of a flight vehicle.

According to an embodiment of any paragraph(s) of this summary, the rocket motor is part of a missile.

According to another aspect of the disclosure, a missile includes: a fuselage; and a multipulse rocket motor within the fuselage, the mutlipulse rocket motor including: a primary pulse; and a secondary pulse fired after the primary pulse; wherein the secondary pulse includes a thermal insulator around a propellant grain of the secondary pulse; and wherein the thermal insulator defines channels therein.

According to still another aspect of the disclosure, a method of operating a multipulse rocket motor includes: firing a primary pulse of the rocket motor; pressuring channels around a secondary pulse of the rocket motor, using pressurized gasses from firing of the primary pulse; and following the firing of the primary pulse, firing the secondary pulse.

While a number of features are described herein with respect to embodiments of the disclosure; features described with respect to a given embodiment also may be employed in connection with other embodiments. The following description and the annexed drawings set forth certain illustrative embodiments of the disclosure. These embodiments are indicative, however, of but a few of the various ways in which the principles of the disclosure may be employed. Other objects, advantages, and novel features according to aspects of the disclosure will become apparent from the following detailed description when considered in conjunction with the drawings.

### BRIEF DESCRIPTION OF THE DRAWINGS

The annexed drawings, which are not necessarily to scale, show various aspects of the disclosure.

FIG. 1 is a schematic view of a missile that has a multipulse rocket motor, according to an embodiment.

FIG. 2 is a side sectional view of the multipulse rocket motor of the missile of FIG. 1.

FIG. 3 is a side sectional view of part of the multipulse rocket motor of FIG. 2, focused on the secondary pulse of the rocket motor.

FIG. 4 is a cross-sectional view of the secondary pulse of FIG. 3.

FIG. 5 is a high-level flow chart of a method of operating a rocket motor according to an embodiment.

FIG. 6 is a schematic view of another alternate embodiment multipulse rocket motor.

### DETAILED DESCRIPTION

A multipulse rocket motor includes a secondary pulse, fired after a primary pulse of the motor, that includes a thermal insulator having channels therein, around a propellant grain of the secondary pulse. The channels provide a way to equalize pressure on the propellant grain of the secondary pulse, to reduce stresses on the propellant grain as the primary pulse is operating. The channels may extend along most or substantially all of a length of the secondary pulse. The channels may be defined by material strips of thermal insulator material evenly circumferentially spaced around the secondary pulse.

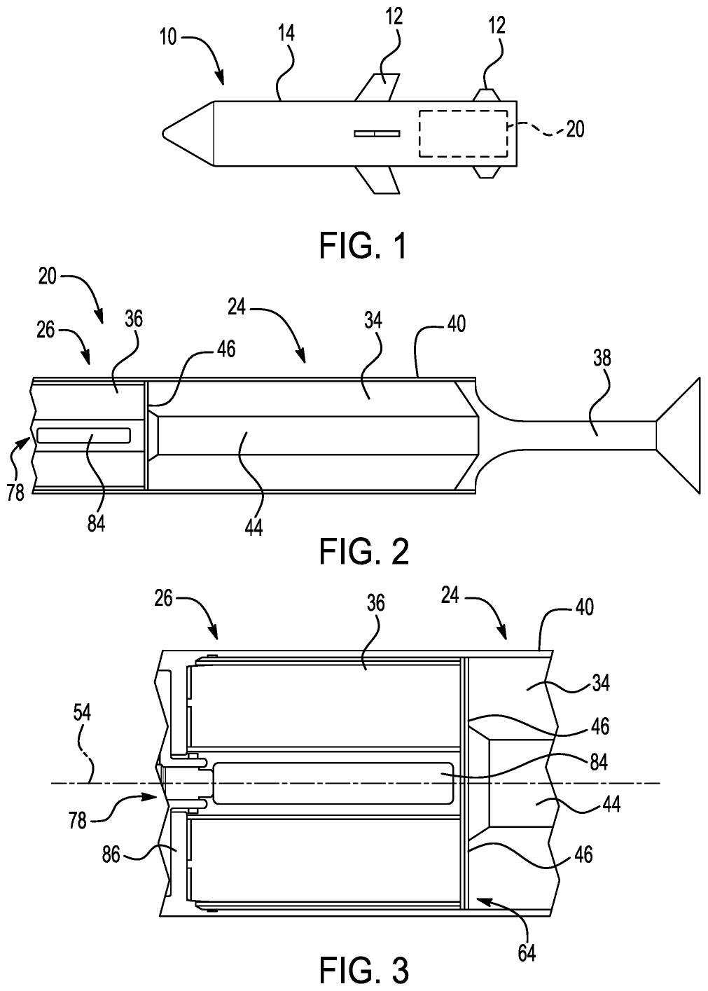

FIG. 1 shows a missile 10, and FIG. 2 shows a propulsion system 20 of the missile 10. The missile 10 includes fins 12 on a fuselage 14. The missile 10 is provided as a sample of a vehicle that includes the propulsion system 20. Propulsion systems as described herein may be part of a wide variety of vehicles, such as different types of air vehicles, for example munitions.

The propulsion system 20 is a multipulse rocket motor, having a primary pulse 24 and a secondary pulse 26. The pulses 24 and 26 have respective propellant grains 34 and 36, and share the same nozzle 38, with products from burning of the propellant grains 34 and 36 passing through the nozzle 38. The pulses 24 and 26 are ignited individually and in sequence, with the primary pulse 24 fired before the secondary pulse 26. A casing 40 may enclose or contain both of the pulses 24 and 26.

The pulses 24 and 26 may provide different levels of thrust, and/or different durations of thrust. The pulses 24 and 26 may be configured for different phases of flight, and/or for different functions during flight. The pulses 24 and 26 may have the same propellant, or different propellants. The pulses 24 and 26 may have the same grain geometry, or different grain geometries. In the illustrated embodiment there is one secondary pulse, the secondary pulse 26, but alternatively there could be multiple secondary pulses that are fired after the primary pulse either individually or in groups.

The primary pulse propellant grain 34 may have any of a variety of suitable shapes/configurations, for instance having a central combustion chamber 44 where combustion occurs. A barrier 46 between the propellant grains 34 and 36 allows combustion of the primary pulse propellant grain 34 without triggering combustion of the secondary pulse propellant grain 36. The barrier 46 may be made of rubber or another suitable material that prevents combustion therethrough and acts as a thermal insulator, such as a suitable flexible thermal insulator material.

The propellant grains 34 and/or 36 may be cast-in-case grains that are cast in place in the casing 40. Alternatively the propellant grains 34 and/or 36 may be other types of propellant grains, such as cartridge-loaded grains.

The combustion in the propellant grain 34 produces pressurized gasses, which means increased pressure in the combustion chamber 44, and in the primary pulse 24 in general. This pressure in the primary pulse 24 puts stresses on the secondary pulse propellant grain 36, and/or on the thermal barrier 46.

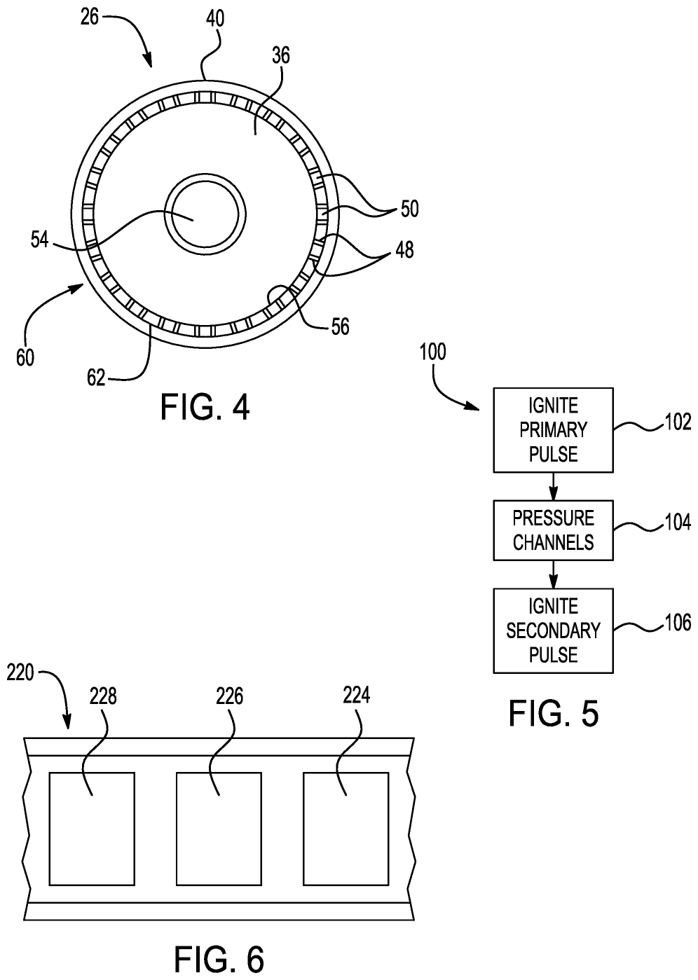

With reference now in addition to FIGS. 3 and 4, to equalize this pressure, and thereby reduce stresses on the secondary pulse propellant grain 36, which perhaps will prevent damage to the secondary pulse propellant grain 36 from the stresses, the secondary pulse 26 has a series of channels 48 around the secondary pulse propellant grain 36. The channels 48 are defined by and between a series of castellation strips 50 that are oriented longitudinally (axially), parallel to a longitudinal axis 54 of the rocket motor 20, and spaced circumferentially (perimetrically) around a perimeter around the propellant grain 36. The strips 50 may be secured to (or in contact with) a cylindrical thermal insulator 56 that is around the secondary pulse propellant grain 36. The cylindrical insulator 56 may be made of the same material as the barrier 46, and the barrier 46 and the cylindrical insulator 56 may be parts of a single covering 60. The strips 50 may be separate pieces or may be parts of the cylindrical insulator 56. The strips 50 may be between the cylindrical insulator 56 and an insulating liner 62 of the casing 40. As another alternative the strips 50 may be parts of the liner 62.

There may be any of a variety of numbers of the strips 50. In the illustrated embodiment there are 24 of the strips 50. In other embodiments there may be at least four strips, or any higher integer number of strips. Although the strips 50 are described as circumferentially evenly spaced around the perimeter of the secondary pulse propellant grain 36, alternatively the spacing may be nonuniform. And although the strips 50 are described as parallel to the longitudinal axis 54, other orientations are possible.

In one embodiment the strips 50 may each have a thickness of 1.27 mm (0.05 inches), and may each be of a width of 4.14 mm (0.163 inches). Many other dimensions for the strips 50 are possible.

The channels 48 between the strips 50 may extend all or substantially all of a length of the secondary pulse propellant grain 36. Alternatively the channels 48 may extend less than the full length of the secondary pulse propellant grain 36, for example extending at least 50% of the length, at least 75% of the length, or at least 90% of the length. Having the channels 48 over more of the length of the propellant grain 36 is advantageous in equalizing pressure over more of the surface area of the propellant grain 36. However, it is most important to have the equalization of pressure where the secondary pulse 26 is closest to the primary pulse 24, such as near the barrier 46.

The channels 48 are in fluid communication with the primary pulse 24, such as through an open region 64 around a perimeter of the barrier 46. This allows pressure in the channels 48 to rise along with pressure within the burning primary pulse 24. This reduction in the pressure differential on the different parts of the propellant grain 36, which reduces stresses on the propellant grain 36, and/or on the thermal barrier 46.

The illustrated embodiment shows one non-limiting possible configuration of the multiple grains. As shown, the secondary pulse propellant grain 36 may have an annular shape (a center-perforated grain).

The secondary pulse propellant grain 36 defines a central aperture 78, to allow access for a first pulse initiator/igniter 84. The first pulse initiator 84 is used to initiate combustion in the first propellant grain 34. The initiator 84 may be an electrical igniter, or another suitable sort of mechanism for initiating combustion in the propellant grain 34. A secondary pulse initiator/igniter 86 may be used to initiate combustion in the secondary pulse propellant grain 36.

An advantage of the presence of the strips 50, and the channels 48 defined by the strips 50, is a reduction of stresses. If the strips 50 and the channels 48 were to be omitted, preventing pressurization around the secondary pulse propellant grain 36, then the strains in the secondary pulse propellant grain, and in the thermal barrier, would be much higher, particularly in the vicinity of (closest to) the first pulse.

FIG. 5 shows a high-level flow chart of a method 100 of operating a multipulse rocket motor, such as the propulsion system 20 (FIG. 2). In step 102 a primary pulse, such as the primary pulse 24 (FIG. 2) is ignited, causing combustion in the primary pulse propellant 34 (FIG. 2). This combustion creates pressurized gasses, which in step 104 pressurize channels 48 (FIG. 4) in an insulator 56 (FIG. 4) around the secondary pulse propellant 36 (FIG. 3). This pressurizing helps maintain the structural integrity of the propellant 36. Finally, after the firing of the primary pulse 24, in step 106 the secondary pulse 26 (FIG. 2) is fired.

Many other grain configurations are possible. For example one or both pulses could alternatively have a non-circular cross-section shape, such as square, rectangular, polygonal, oval, and/or shapes composed of curved and/or straight portions, with channels enabling pressurization around a perimeter of a secondary pulse, inside a casing. The secondary pulse may have the same cross-section shape as a primary pulse, or the pulses may have different cross-section shapes.

FIG. 6 shows another alternate embodiment, a propulsion system 220 that has a primary pulse 224 and multiple secondary pulses 226 and 228. One or both of the secondary pulses 226 and 228 may include pressure-equalizing channels as described above.

The propulsion systems described herein may be used in any of a variety of devices that use multiple-pulse rocket motors. Examples include missiles and any of a variety of other suitable flight vehicles and space vehicles.

Although the disclosure has been shown and described with respect to a certain embodiment or embodiments, equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the disclosure. In addition, while a particular feature of the disclosure may have been described above with respect to only one or more of several illustrated embodiments, such feature may be combined with one or more other features of the other embodiments, as may be desired and advantageous for any given or particular application.

1. A multipulse rocket motor comprising:
a primary pulse; and
a secondary pulse extending from a proximal end facing the primary pulse to an opposing distal end, the secondary pulse fired after the primary pulse;
wherein the secondary pulse includes a thermal insulator around a propellant grain of the secondary pulse; and
wherein the thermal insulator defines channels therein, the channels extending from an open region proximal the primary pulse toward the distal end of the secondary pulse, thereby enabling movement of pressurized gasses from the primary pulse to pressurize the secondary pulse prior to firing the secondary pulse.

2. The multipulse rocket motor of claim 1, wherein the channels are in fluid communication with the primary pulse.

3. The multipulse rocket motor of claim 1, wherein the thermal insulator is around a perimeter of the secondary pulse.

4. The multipulse rocket motor of claim 1, wherein the thermal insulator is between the propellant grain of the secondary pulse, and a casing surrounding the thermal insulator.

5. The multipulse rocket motor of claim 1, wherein the channels extend longitudinally along a length of the secondary pulse.

6. The multipulse rocket motor of claim 1, wherein the thermal insulator includes material strips between an inner insulator layer and an outer insulator layer.

7. The multipulse rocket motor of claim 6, wherein the material strips include at least four material strips.

8. The multipulse rocket motor of claim 6, wherein the material strips are evenly perimetrically spaced about the thermal insulator.

9. The multipulse rocket motor of claim 6, wherein the material strips extend longitudinally less than all of a length of the secondary pulse.

10. The multipulse rocket motor of claim 1, wherein the propellant grain of the secondary pulse is a cast-in-case propellant grain.

11. The multipulse rocket motor of claim 1, wherein the secondary pulse is an annular secondary pulse.

12. The multipulse rocket motor of claim 1, wherein the thermal insulator is cylindrical.

13. The multipulse rocket motor of claim 1, wherein the channels extend at least 75% of a length of the secondary pulse.

14. The multipulse rocket motor of claim 1, wherein the channels extend at least 90% of a length of the secondary pulse.

15. The multipulse rocket motor of claim 1, further comprising a barrier between the primary pulse and the secondary pulse.

16. The multipulse rocket motor of claim 15, wherein the barrier is a flexible barrier.

17. The multipulse rocket motor of claim 1, wherein the multipulse rocket motor is part of a flight vehicle.

18. A missile comprising:
a fuselage; and
a multipulse rocket motor within the fuselage, the mutlipulse rocket motor including:
a primary pulse; and
a secondary pulse fired after the primary pulse;
wherein the secondary pulse includes a thermal insulator around a propellant grain of the secondary pulse, the thermal insulator extending from a proximal end facing the primary pulse to an opposing distal end; and
wherein the thermal insulator defines channels therein, the channels extending from an open region proximal the primary pulse toward the distal end of the thermal insulator thereby enabling movement of pressurized gasses from the primary pulse to pressurize the secondary pulse prior to firing the secondary pulse.

19. A method of operating a multipulse rocket motor, the method comprising:
firing a primary pulse of the rocket motor;
pressuring channels around a secondary pulse of the rocket motor, using pressurized gasses from firing of the primary pulse; and
following the firing of the primary pulse, firing the secondary pulse.
